(19) United States
(12) Patent Application Publication
(10) Pub. No.: US 2007/0124465 A1
(43) Pub. Date: May 31, 2007

(54) Synchronized network and process performance overview

(76) Inventors: Patrick J. Malloy, Washington, DC (US); Steven Baron, Nashua, NH (US); Antoine Dunn, Kensington, MD (US)

Correspondence Address: ROBERT M. MCDERMOTT, ESQ., 1824 FEDERAL FARM ROAD, MONTROSS, VA, 22520, US

(21) Appl. No.: 11/639,864

(22) Filed: Dec. 15, 2006

Related U.S. Application Data
(63) Continuation-in-part of application No. 11/505,176, filed on Aug. 16, 2006.
(60) Provisional application No. 60/709,762, filed on Aug. 19, 2005.
(60) Provisional application No. 60/750,665, filed on Dec. 15, 2005.

(51) Int. Cl. G06F 15/173

(52) U.S. Cl. 709/224

(57) ABSTRACT

A visualization system analyzes the data from a first capture system that captures communication events to and from a processing node, and a second capture system that captures processing events at the processing node, synchronizes the data to a common time base, and presents an integrated display of these communication and processing events. Timing diagrams are preferably used to display the processing events, and data-exchange charts are preferably used to display the communication events.

This application is a continuation in part of U.S. patent application Ser. No. 11/505,176, filed 16 Aug. 2006, the contents of which is incorporated by reference herein, and claims the benefit of U.S. Provisional Patent Applications 60/709,762 filed 19 Aug. 2005, and 60/750,665, filed 15 Dec. 2005.

### BACKGROUND AND SUMMARY OF THE INVENTION

This invention relates to the field of computer applications, and in particular to distributed applications that include communications among processors on a network.

With advances in networking technology, distributed applications continue to grow in popularity, and in complexity. In a typical distributed application, a client device may initiate the application, and the application may execute a request for data services at a remote server, and this remote server may in turn request data or other processing from other remote servers. The executed processes at the servers may be specific components of the application residing at the servers, or they may be components provided by the servers and accessed by the application.

Users of an application are generally sensitive to performance and reliability issues associated with the application, and in a competitive market, will generally avoid slow or unreliable applications. Application developers are also sensitive to these issues, to assure that their developed product remains competitive. In like manner, service providers are also sensitive to these issues, to assure that their provided service is not the cause of performance and reliability problems that may affect their customers.

Tools are available for assessing network traffic performance, as are tools for assessing processing performance. The ACE system from OPNET Technologies, Inc., of Bethesda, MD, for example, captures data transmissions associated with an application across a network, and presents the information as a data exchange chart, or as a Gantt chart, that illustrates the time spent communicating the application messages between nodes on the network, as well as the time spent at each node. The OPENVIEW GLANCEPLUS system from Hewlett-Packett, on the other hand, captures processing system performance, including such parameters as CPU processing time, disk transfer rates, cache page faults, and so on.

As applications and networks increase in complexity, the distinction between the traditionally separate tasks of network analysis and processing analysis is becoming less clear. As processing performance becomes more and more dependent upon the amount and type of traffic arriving at a processing server, or the capacity of the network to accept traffic from the server, the processing system manager needs to address how network activity affects the system's performance. And, as network performance becomes more and more dependent upon the amount and type of delays occurring at the processing server, or the capacity of the server to accept traffic from the network, the network system manager needs to address how the processing system's performance affects the network's performance.

It would be advantageous to provide an integrated view of network traffic and processor system performance. By providing a synchronized display of traffic events and process events at one or more nodes of a network, the analysis of network and/or process performance can be performed in the context of an interrelated and interdependent set of traffic and process events.

This advantage and others are achieved by a method and system that include a first capture system that captures communication events, and a second capture system that captures processing events related to the application. A visualization system analyzes the data captured by each of the capture systems, synchronizes the data to a common time base, and presents an integrated display of these communication and processing events.

### BRIEF DESCRIPTION OF THE DRAWINGS

The invention is explained in further detail, and by way of example, with reference to the accompanying drawings wherein:

FIG. 1 illustrates an example network with traffic and process monitoring components coupled to an integrated analysis system in accordance with this invention.

FIGS. 2A and 2B illustrate example performance displays for process and traffic events.

FIGS. 3A and 3B illustrate example user interface screens for controlling the integrated display of process and traffic events in accordance with this invention.

Throughout the drawings, the same reference numerals indicate similar or corresponding features or functions. The drawings are included for illustrative purposes and are not intended to limit the scope of the invention.

### DETAILED DESCRIPTION

In the following description, for purposes of explanation rather than limitation, specific details are set forth such as the particular architecture, interfaces, techniques, etc., in order to provide a thorough understanding of the concepts of the invention. However, it will be apparent to those skilled in the art that the present invention may be practiced in other embodiments, which depart from these specific details. In like manner, the text of this description is directed to the example embodiments as illustrated in the Figures, and is not intended to limit the claimed invention beyond the limits expressly included in the claims. For purposes of simplicity and clarity, detailed descriptions of well-known devices, circuits, and methods are omitted so as not to obscure the description of the present invention with unnecessary detail.

The invention is presented in the context of assessing network and process performance at a server that is accessed by a client and performs tasks on behalf of the client. In the context of this invention, a network event is defined as a communication of a message from a source node to a destination node, and network performance is defined as a metric related to communications between pairs of source and destination nodes. The measure of effectiveness includes, for example, the volume of traffic communicated between the pair of nodes during a given period of time, the delay associated with the communication of messages between the pair, and so on. A processing event, on the other hand, is any event at the processing system that sends or receives the messages, independent of the particular pair of nodes associated with each message. Process performance is defined as a metric associated with the processing events, independent of the particular application that sends or receives the messages, and includes, for example, the percentage of time that the processing CPU is being used, the amount of data transferred to and from storage, the efficiency of cache processing, and so on. One of ordinary skill in the art will recognize that the principles of this invention are applicable to the analysis of performance at any device or system that processes and communicates data over time.

FIG. 1 illustrates an example network comprising a client 110, server 120, and database 130. This simple network is used as a paradigm for a typical configuration wherein a client requests information from a server, the server processes the request, accesses one or more databases to fulfill the request, then sends the requested information to the client. In a typical embodiment, the server 120 will also be servicing other clients 111, 112, accessing other databases 131, 132, other servers, and so on.

In accordance with this invention, an analysis system 150 is configured to receive information from a process monitor 122 and traffic monitor 124 that are coupled to, or integral to, the server 120. These monitors 122, 124 are configured to capture performance metrics associated with the processing of data at the server and the communication of data to and from the server, respectively.

In the above referenced parent application to this application, “CAPTURE, ANALYSIS, AND VISUALIZATION OF CONCURRENT SYSTEM AND NETWORK BEHAVIOR OF AN APPLICATION”, Ser. No. 11/505,176, filed 16 Aug. 2006 for Baron et al., techniques are disclosed for tracing traffic and process events related to a target application by instrumenting the application processes on the processing server to effect the capture of relevant process events. This invention is premised on the observation that network and process performance often needs to be analyzed and assessed independent of a particular application; or, if an application is being assessed, the analysis often needs to also address how the application is being affected by the overall network and process performance in the context of multiple concurrent applications.

The process monitor 122 preferably includes one or more conventional process monitoring tools, such as the aforementioned OPENVIEW GLANCEPLUS tool from HP, or others, such as PANORAMA from OPNET and the various PERFMON (Performance Monitor) embodiments available from Microsoft, HP, Sun Systems, and so on. The process monitor captures information that is specific to the server 120, such as CPU and disk utilization percentages, average disk queue length, cache hit ratio, numbers of blocked and unblocked users, and a variety of measures per unit time, such as numbers of system calls or interrupts per second, logical and physical disk reads and writes per second, page faults and cache faults per second, and so on. The process monitor 122 also captures information related to the network interface to the server, such as bytes or packets sent or received per second, output queue length, and so on.

The traffic monitor 124, on the other hand, captures information specific to the messages communicated over the network, including an identification of source and destination nodes for each message, the size of each message, the message data, and so on. As noted above, tools such as OPNET's ACE system are particularly well suited for controlling and managing the capture of network performance metrics.

In a preferred embodiment of this invention, the analysis system 150 is configured to facilitate control of each of the process monitor 122 and traffic monitor 124. This control may be automated or manual, or a combination of both. In the automated mode, events at one of the monitors 122, 124 trigger the start of data collection at the other monitor. For example, detection of a message at the traffic monitor 124 to or from a particular source or destination node may trigger the start of data collection at the process monitor 122; or, a significant change to one of the monitored processing parameters at the process monitor 122 may trigger the start of data collection at the traffic monitor 124. Such triggering is particularly advantageous when Quality of Service (QoS) guarantees are in place in the network. Any violation of predetermined thresholds triggers the start of data collection at both monitors 122, 124 so that appropriate analysis can be performed. Alternatively, or additionally, the analysis system may initiate the data collection on a periodic basis, or based on events at other nodes in the network, and so on. In the manual mode, the user may be provided the option of viewing the activity at one of the monitors, and initiating data collection at the other on demand. Optionally, the monitors 122 and 124 may be configured to continuously monitor the process and traffic events, and the analysis system is configured to control storing of the data for subsequent viewing and analysis, automatically or manually.

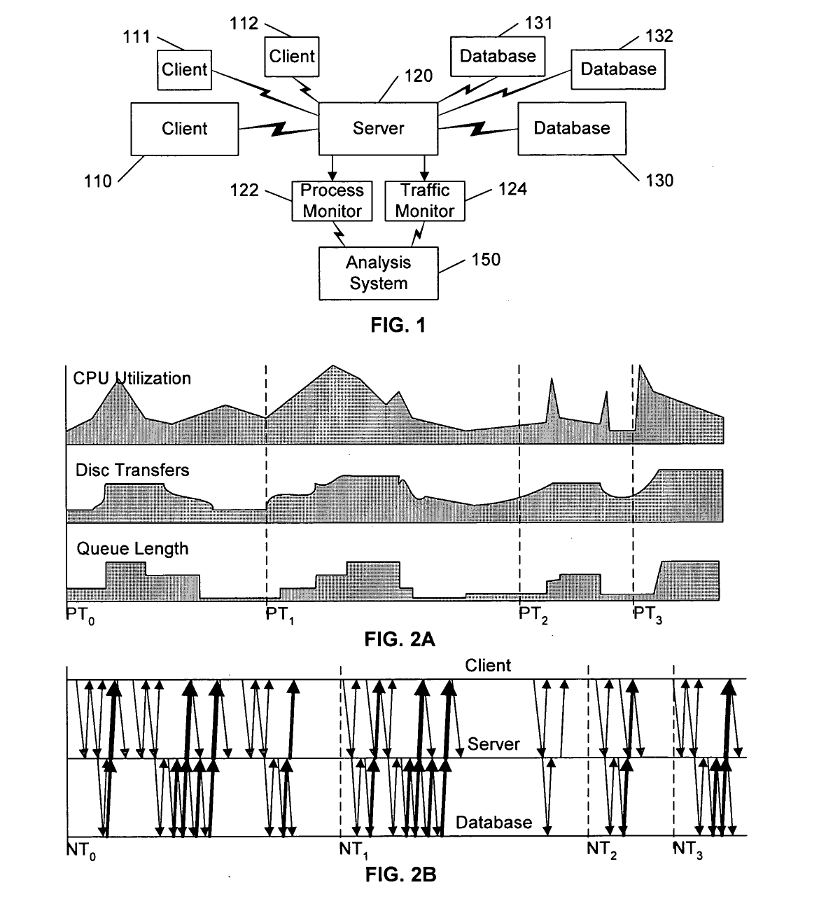

FIGS. 2A and 2B illustrate example graphic displays of process and network performance, respectively. FIG. 2A illustrates the plots of data from the process monitor 122, and, in this example, are identified as plots of CPU utilization, disk transfers, and disk queue as a function of processor time PT. Typically, process monitoring tools use the host server's CPU clock as the time base.

FIG. 2B illustrates a plot of data exchanges between the client and server, and between the server and database as a function of network time NT. Each message is identified as an arrow from one “tier” to the other, the arrow-head identifying the destination tier. The thickness of the arrows in this example serve to illustrate the size/volume of each message; other techniques may also or alternatively be used to distinguish message size, such as the use of color to distinguish different ranges of size. If the time-scale is large, alternative formats, such as a histogram display, may be used when individual message arrows become infeasible to display, or become indistinguishable due to density; color may also be used in such histograms, to indicate the proportion of messages of different size ranges.

The inclination of the arrows in FIG. 2B indicates the delay between the transmission from the source tier and the reception at the destination tier. The transmission time is assigned at the source tier, and the reception time is assigned at the destination tier. Generally, there may be differences among the time bases used at each tier, and the network time NT is typically a normalized time among these bases, which may or may not correspond to the aforementioned processor time PT used by the process monitor 122. Copending U.S. patent application “SYNCHRONIZING PACKET TRACES”, Ser. No. 10/914,603, filed 6 Aug. 2004 for Malloy et al., teaches techniques for determining a common network time base based on constraint propagation (a message cannot be received before it is transmitted, etc.), and is incorporated by reference herein. In accordance with an aspect of this invention, the process graphs of FIG. 2A and the data exchange chart of FIG. 2B are displayed concurrently so that the correspondence and interdependencies among network events and process events can be visualized.

If, as is typical, the network time NT does not correspond to the processor time PT, some correspondence between the clocks must be established before the data can be properly displayed. In a straightforward embodiment, the user is provided the option of manually inputting an appropriate offset that establishes when the process data starts relative to the traffic data. Alternatively, the user may input a known difference between the network time NT and the process time PT. Each of these options is preferably provided via a graphical user interface. In an interactive embodiment, the user is provided the option of ‘grabbing’ one or more of the graphs or charts of FIGS. 2A, 2B and ‘sliding’ it until the data is properly synchronized, for example, by selecting one of the graphs with a mouse pointer, holding the mouse button down, dragging the graph along a horizontal axis to a desired stopping point, and releasing the mouse button.

Typically, each of the manual synchronization options described above requires that the user have a reasonable understanding of the collected data and/or the process and network monitors 122, 124. In more automated embodiments, the network and process data can be synchronized to a common time base with little or no user interaction.

Any of a variety of techniques may be used to facilitate the automated determination of a common time base. For example, prior to capturing data, the invention could instruct the process monitor 122 and network monitor 124 to synchronize their clocks. This can be accomplished by synchronizing one with the other, or synchronizing each with a global time base, such as those regulated by the Global Positioning System (GPS) or the Network Time Protocol (NTP), or to an arbitrary time base. If the clocks cannot be synchronized prior to capturing data, each of the process monitor 122 and network monitor 124 could supply, with their corresponding capture data, an offset that identifies the difference between their clocks and that of a global clock. Alternatively, if both monitors 122, 124 provide an option to read its current time, the system 150 need merely request the current time from each and adjust the reported times accordingly. As noted above, however, the network time NT used for data exchange charts is often a normalized time based on a post-process analysis of the reported times, and the time at the monitor 124 would not necessarily correspond to this determined network time NT. If the process that determines the normalized network time NT can be configured to set the time base to a select one of the tiers and adjust the other tier time bases accordingly, and if it is known that the traffic monitor 124 at the server 120 uses the server's CPU time, the system 150 need only direct the process to use the time base of the traffic monitor 124 as the normalized network time NT.

If the above manual or automated determinations of a common time base between the process time PT and network time NT cannot be used, other synchronizing techniques, such as pattern-matching may be used. That is, patterns in the graphs of the process events of FIG. 2A can be compared to patterns in the data-exchange graph of FIG. 2B to determine a likely alignment of these displays to a common time base. Consider, for example, the network events to the right of NT1 in FIG. 2B and the disk queue size to the right of PT1 in FIG. 2A. The pattern to the right of NT1 suggests an initial exchange between the client and server, and a corresponding subsequent exchange between the server and the database, with a substantial data transfer from the database to the server and then from the server to the client. This message pattern after time NT1 in FIG. 2B could account for the disc queue size increase after PT1 in FIG. 2A, implying that the time base of FIG. 2A should be moved to the right (advanced) to better align the events of FIG. 2A with the events of FIG. 2B. Other pattern comparisons, such as events at PT2 and NT2, and events at PT3 and NT3, would also suggest the advancement of the process time base to better align these patterns.

In a preferred embodiment, a combination of user interaction and automated synchronization is used. For example, the time base adjustments can be based on prior time shift determinations. That is, if at some prior time it had been determined that the process time PT and network time NT at a particular server differed by a given amount, this amount may be used as an initial offset for providing a common time base, subject to subsequent user adjustment. These and other techniques for determining or approximating a correspondence between the process and network time bases will be evident to one of skill in the art in view of this disclosure.

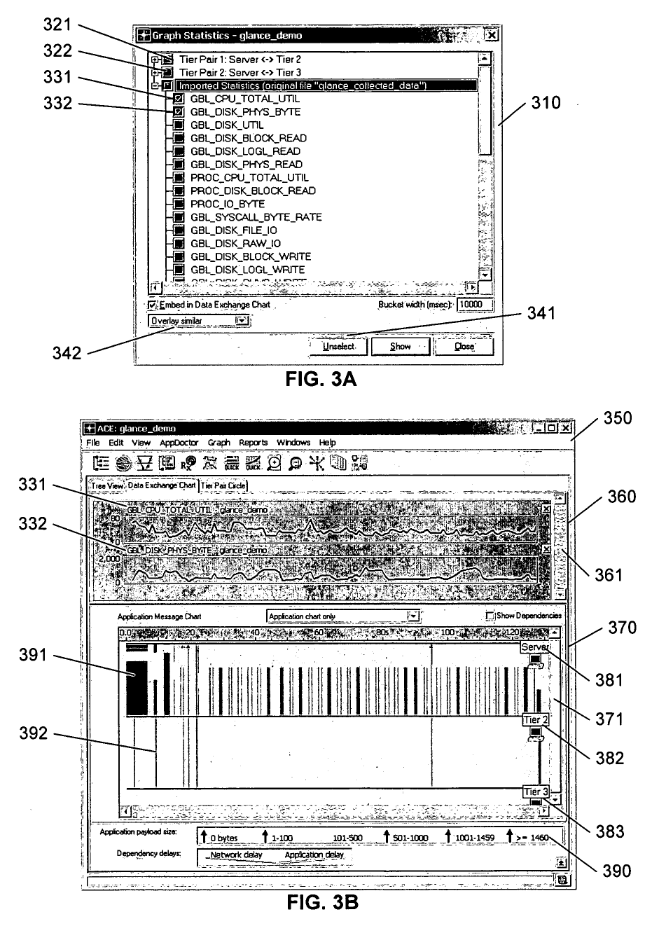

FIGS. 3A and 3B illustrate example user interface screens for an analysis system of this invention.

In a typical embodiment of a processor monitor, such as HP GLANCEPLUS, all of the processing-related data is maintained in a single file for a given processing system, or in a single database. The dialog box of FIG. 3A allows a user to select which time-based statistics/metrics to graph. In a preferred embodiment, time-based metrics related to the network are also provided by the traffic monitor, or the analysis system, including such metrics as application throughput, network throughput, retransmissions, etc. The user interacts with these lists of available time-based processor statistics/metrics 331, 332, etc. and network performance statistics/metrics 321, 322 to select which metrics to include or exclude 341 in the display region 360 of FIG. 3B, discussed below.

In a preferred embodiment, the individual time-based metrics can be overlaid upon each other, using different colors for different metrics. The user is provided the option 342 of having the system overlay all of the selected metrics on a single graph, or having the system overlay sets of similar metrics on each of a plurality of graphs. That is, for example, all of the metrics related to the CPU may be placed on one graph, all of the metrics related to disk-transfers can be placed on another, and so on. Preferably, default similarity sets are provided, and the user is provided the option of defining other sets, selecting the colors to be used within the sets, and so on. Alternatively, each selected metric could be place on a separate graph.

FIG. 3B illustrates the display 350 for analyzing network traffic in conjunction with the selected process performance metrics. At region 360, the performance metrics selected in the dialog box 310 of FIG. 3A are displayed, and in region 370, the data exchange chart is displayed between select tiers 381, 382, 383. The performance metrics and data exchange chart are displayed using the aforementioned common time base, offsetting either the process or traffic time scale to match the other. Furthermore, horizontal scrolling or zooming within either region 360 or 370 will affect the other region, so as to constantly maintain the common time base for both regions.

The process performance metrics are preferably displayed as timing diagrams, while the network traffic data is preferably displayed using data exchange charts; as noted above, traffic performance metrics may also be displayed as timing diagrams in display region 360, with the selected process performance metrics. In the example of FIG. 3B, the CPU utilization (“GBL_CPU_TOTAL_UTIL”) 331 and disk transfer volume (“GBL_DISK_PHYS_BYTE”) 332 metrics from the process file are displayed, and a scroll bar 361 is provided to scroll through the other available process metrics. In like manner, the data exchange sequence 391 between “Server” 381 and “Tier 2” 382 and the data exchange sequence 392 between “Server” 381 and “Tier 3” 383 are shown in area 370, using a common tier-line for the “Server” tier 381. If additional tier-pairs are present in the captured traffic and selected for inclusion in a data exchange chart, a similar scroll bar 371 is provided to select which pairs to display. In the example display 370, a histogram format is used for illustrating the data exchange 391, 392, using different colors for different sized packets, the key for the color being given at 390.

Other interface screens are also provided, including an interface to control the process and traffic monitoring tools, an interface to control the timing offset between the process and traffic time bases, and so on.

The foregoing merely illustrates the principles of the invention. It will thus be appreciated that those skilled in the art will be able to devise various arrangements which, although not explicitly described or shown herein, embody the principles of the invention and are thus within its spirit and scope. For example, although the process monitor 122 and traffic monitor 124 are conventionally different devices or modules, one of skill in the art will recognize in view of the principles presented herein, that a single monitor that incorporates the functions of monitors 122 and 124 can be provided. In like manner, an integrated analysis system could be provided that includes the analysis component 150 and one or both of the monitors 122, 124. These and other system configuration and optimization features will be evident to one of ordinary skill in the art in view of this disclosure, and are included within the scope of the following claims.

In interpreting these claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) each of the disclosed elements may be comprised of hardware portions (e.g., including discrete and integrated electronic circuitry), software portions (e.g., computer programming), and any combination thereof;
f) hardware portions may be comprised of one or both of analog and digital portions;
g) any of the disclosed devices or portions thereof may be combined together or separated into further portions unless specifically stated otherwise;
h) no specific sequence of acts is intended to be required unless specifically indicated; and
i) the term “plurality of” an element includes two or more of the claimed element, and does not imply any particular range of number of elements; that is, a plurality of elements can be as few as two elements, and can include an immeasurable number of elements.

We claim:

1. A system comprising:
a network monitoring tool that is configured to capture traffic data corresponding to traffic events to and from a processing node,
a process monitoring tool that is configured to capture process data corresponding to processing events at the processing node,
an analysis system that is configured to receive the traffic data and process data and to display the traffic data and process data using a common time base.

2. The system of claim 1, including the processing node.

3. The system of claim 1, wherein the analysis system automatically determines the common time base.

4. The system of claim 3, wherein the analysis system determines the common time base based on a correlation between the traffic events and process events.

5. The system of claim 4, wherein the analysis system determines the correlation based on pattern recognition.

6. The system of claim 1, wherein the analysis system includes a user interface that facilitates a user's control of the analysis system to determine the common time base.

7. The system of claim 1, wherein the analysis system displays the traffic data using a data exchange chart.

8. The system of claim 7, wherein the analysis system displays a volume metric associated with the traffic data using at least one of a color parameter and a size parameter.

9. The system of claim 8, wherein the analysis system displays the traffic data using a histogram format.

10. The system of claim 7, wherein the analysis system displays the process data using a timing diagram.

11. The system of claim 10, wherein the data exchange chart and the timing diagram are synchronized relative to the common time base, such that a change of the display of the common time base in the data exchange chart effects a corresponding change of the display of the timing diagram, and a change of the display of the common time base in the timing diagram effects a corresponding change of the display of the data exchange chart.

12. The system of claim 1, wherein the analysis system displays the process data using a timing diagram.

13. The system of claim 1, wherein the display of the traffic data and the display of the process data are synchronized relative to the common time base, such that a change of the display of the traffic data relative to the common time base effects a corresponding change of the display of the process data relative to the common time base, and a change of the display of the process data relative to the common time base effects a corresponding change of the display of the traffic data relative to the common time base.

14. The system of claim 1, wherein
the process data corresponds to a plurality of process metrics, and
the analysis system is configured to facilitate a user's selection of one or more process-metrics for displaying each selected process-metric.

15. The system of claim 14, wherein the analysis system is configured to facilitate display of two or more process-metrics of the selected process-metrics in an overlay mode.

16. The system of claim 15, wherein the analysis system is configured to use different colors to display each of the two or more process-metrics in the overlay mode.

17. The system of claim 1, wherein the analysis system is configured to control the network monitoring tool.

18. The system of claim 17, wherein the analysis system is configured to control the network monitoring tool based on one or more of the processing events.

19. The system of claim 17, wherein the analysis system is configured to control the process monitoring tool.

20. The system of claim 1, wherein the analysis system is configured to control the process monitoring tool.

21. The system of claim 20, wherein the analysis system is configured to control the process monitoring tool based on one or more of the traffic events.

22. An analysis system comprising:
a receiver component that is configured to:
receive traffic data corresponding to traffic events from a network monitoring tool and
receive process data corresponding to processing events from a process monitoring tool,
an analysis component that is configured to facilitate determination of a common time base between the traffic events and processing events, and
a display component that is configured to display the traffic data and process data using the common time base.

23. The system of claim 22, wherein the analysis component determines the common time base based on a correlation between the traffic events and process events.

24. The system of claim 23, wherein the analysis component determines the correlation based on pattern recognition.

25. The system of claim 22, wherein the analysis component includes a user interface that facilitates a user's control of the analysis system to determine the common time base.

26. The system of claim 22, wherein the display component displays the traffic data using a data exchange chart.

27. The system of claim 26, wherein the display component displays a volume metric associated with the traffic data using at least one of a color parameter and a size parameter.

28. The system of claim 27, wherein the display component displays the traffic data using a histogram format.

29. The system of claim 26, wherein the analysis system displays the process data using a timing diagram.

30. The system of claim 29, wherein the display component is configured to synchronously display the data exchange chart and the timing diagram, such that a change in the data exchange chart relative to the common time base effects a corresponding change of the display of the timing diagram, and a change in the timing diagram relative to the common time base effects a corresponding change of the display of the data exchange chart.

31. The system of claim 22, wherein the display component displays the process data using a timing diagram.

32. The system of claim 22, wherein the display of the traffic data and the display of the process data are synchronized relative to the common time base, such that a change of the display of the traffic data relative to the common time base effects a corresponding change of the display of the process data relative to the common time base, and a change of the display of the process data relative to the common time base effects a corresponding change of the display of the traffic data relative to the common time base.

33. The system of claim 22, wherein
the process data corresponds to a plurality of process metrics, and
the analysis component is configured to facilitate a user's selection of one or more process-metrics for displaying each selected process-metric.

34. The system of claim 33, wherein
the analysis component is configured to facilitate display of two or more process-metrics of the selected process-metrics in an overlay mode.

35. The system of claim 34, wherein
the analysis component is configured to use different colors to display each of the two or more process-metrics in the overlay mode.

36. The system of claim 22, wherein
the analysis component is configured to control the network monitoring tool.

37. The system of claim 36, wherein
the analysis component is configured to control the network monitoring tool based on one or more of the processing events.

38. The system of claim 36, wherein
the analysis component is configured to control the process monitoring tool.

39. The system of claim 22, wherein
the analysis component is configured to control the process monitoring tool.

40. The system of claim 39, wherein
the analysis system is configured to control the process monitoring tool based on one or more of the traffic events.

41. A method comprising:
capturing traffic data from a network monitoring tool corresponding to traffic events to and from a processing node,
capturing process data from a process monitoring tool corresponding to processing events at the processing node,
determining a common time base between the traffic data and process data, and
displaying the traffic data and process data using the common time base.

42. The method of claim 41, wherein determining the common time base includes determining a correlation between the traffic events and process events.

43. The method of claim 42, wherein determining the correlation includes pattern recognition.

44. The method of claim 41, wherein determining the common time base includes receiving a user input that facilitates determining the common time base.

45. The method of claim 41, wherein displaying the traffic data includes displaying a data exchange chart.

46. The method of claim 45, wherein displaying the data exchange chart includes displaying a volume metric associated with the traffic data using at least one of a color parameter and a size parameter.

47. The method of claim 46, wherein displaying the traffic data includes displaying the traffic data using a histogram format.

48. The method of claim 45, wherein displaying the process data includes displaying a timing diagram.

49. The method of claim 48, including:
changing the data exchange chart relative to the common time base based on a corresponding change of the display of the timing diagram, and
changing the timing diagram relative to the common time base based on a corresponding change of the display of the data exchange chart.

50. The method of claim 41, wherein displaying the process data includes displaying a timing diagram.

51. The method of claim 41, including:
changing the data exchange chart relative to the common time base based on a corresponding change of the display of the timing diagram, and
changing the timing diagram relative to the common time base based on a corresponding change of the display of the data exchange chart.

52. The method of claim 41, wherein
the process data corresponds to a plurality of process metrics, and
the method includes detecting a user's selection of one or more process-metrics for displaying each selected process-metric.

53. The method of claim 52, wherein displaying the selected process-metrics includes displaying two or more process-metrics of the selected process-metrics in an overlay mode.

54. The method of claim 53, wherein displaying the selected process-metrics includes displaying two or more process-metrics of the selected process-metrics using different colors in the overlay mode.

55. The method of claim 41, including controlling the network monitoring tool.

56. The method of claim 41, including controlling the network monitoring tool based on one or more of the processing events.

57. The method of claim 56, including controlling the process monitoring tool.

58. The method of claim 41, including controlling the process monitoring tool.

59. The method of claim 41, including controlling the process monitoring tool based on one or more of the traffic events.
